(19) United States
(12) Patent Application Publication
(10) Pub. No.: US 2010/0009312 A1
(43) Pub. Date: Jan. 14, 2010

(54) HAND-HELD INSTRUMENT FOR DENTAL OR SURGICAL USE

(75) Inventor: Luc MAITRE, Epauvillers (CH)

Correspondence Address: YOUNG & THOMPSON, 209 Madison Street, Suite 500, Alexandria, VA, 22314, US

(73) Assignee: BIEN-AIR HOLDING SA, Bienne (CH)

(21) Appl. No.: 12/439,027

(22) PCT Filed: Aug. 14, 2007
(86) PCT No.: PCT/EP07/58372

§ 371 Date: Feb. 26, 2009

(30) Foreign Application Priority Data
Aug. 30, 2006 (EP) 06119749.7

(51) Int. Cl. A61C 1/00

(52) U.S. Cl. 433/131

(57) ABSTRACT

A hand-held medical instrument intended to turn a movable tool at high speed, includes a clamping mechanism for fixing the tool, a motor mechanism for the driving rotation of the clamping mechanism and a coupling system (21) for the clamping mechanism with the motor mechanism, the system including a hollow tree (28) inside which the end (20) of the tree of the clamping mechanism is able to slide. The coupling system (21) and the end (20) of the tree of the clamping mechanism are assembled together using a rod fixation in which the pins (26) of the end (20) are held, after turning, by a stop (30) arranged inside the hollow tree (28).

### TECHNICAL FIELD

The present invention relates to the field of medical instruments. It more particularly concerns a hand-held instrument intended to turn a moveable tool at high speed, the end of which constitutes a burr or similar member, usable in dental offices or laboratories as well as in microsurgery.

### BACKGROUND ART

One instrument of this type is described, for example, in document WO 2005/089666. Typically, the shank of the tool is held by a clamp arranged inside a hollow rotating shaft driven at its end by an electric motor or an air turbine and mounted by bearings in a fixed tubular sheath. Gripping and releasing of the clamp is done by turning a sleeve mounted to rotate on the shaft in one direction or the other.

An instrument of this type is generally realized in three parts, namely a clamping mechanism with its drive shafts and driven shafts for fixing of the tool, a motor mechanism for driving the clamp mechanism in rotation and a system for coupling the clamp mechanism with the motor mechanism.

These three components must be able to be easily separated from each other in order to enable the same motor mechanism to actuate different types of clamp mechanisms and to allow the replacement of the coupling system subject to stresses which accelerate its wear.

We will first refer to FIG. 1, which shows, in an embodiment of the prior art, the manner in which the three components are assembled. In order to facilitate reading, this description will use the words “upstream” and “downstream” to designate the end of the instrument from which the tool is driven in rotation (right part of the drawing) and its end bearing the operative tip of the tool (left part of the drawing), respectively. Moreover, the drawing does not show the upstream and downstream parts of the instrument because these can be identical to those described in the aforementioned document WO 2005/089666, to which one may refer to understand the manner in which the tool is driven.

In FIG. 1, we have shown, in 10, the upstream end of the drive shaft of the clamp mechanism, in 11 the downstream end of the shaft of the motor mechanism and in 12 the coupling system according to the invention.

This comprises a hollow shaft 13 provided, at its downstream end, with two diametrically opposite oblong axial windows 14. The upstream end 10 of the shaft of the clamp mechanism is mounted sliding in the downstream end of the shaft 13 and passed through by a removable connection pin 15, the travel of which is axially limited by the two windows 14. A split bushing 16, clipped around the portion of the shaft 13 which includes these windows, ensures holding in place of the pin 15. In order to separate the drive shaft from the clamp mechanism of the coupling system, it is therefore necessary to unclip the socket 16 in order to reveal the pin 15 which can therefore be removed and thereby makes it possible to separate the shafts 10 and 13.

The upstream end of the shaft 13 is provided with two diametrically opposite oblong axial notches 17 (only one appears in the drawing) which are sized and formed so as to receive two fins 18 (only one appears in the drawing) which terminate the shaft 11 of the motor mechanism. According to one variation of embodiment, the number of pairs of diametrically opposite notches can be higher, in order to facilitate the insertion of the fins 18.

One will note, lastly, the presence of a spring 19 which is arranged around the shaft 10 and which pushes the shaft 13 in the upstream direction. Thanks to this spring, even if the practitioner has not taken care to stop the motor when he connects the motor mechanism to the coupling system, the shaft 13 always has the possibility of retracting more or less in order to facilitate the operation.

Although such a connection mode of the motor mechanism to the coupling system is fully satisfactory, the same is not true for the connection of the coupling system to the drive shaft of the clamp mechanism. Indeed, the solution described above calls for a relatively complex socket, the realization of which is not easy and the assembly or disassembly of which requires a special tool. Moreover, this clipped split bushing does not guarantee holding capable of resisting a connection of the coupling system to the motor mechanism when the motor mechanism is still in rotation.

### SUMMARY OF THE INVENTION

The present invention aims in particular to provide a hand-held instrument free of the abovementioned drawbacks.

To achieve this aim, the invention proposes, as described in document DE 197 07 373, a hand-held instrument comprising a clamp mechanism for fixing of the tool, a motor mechanism for driving in rotation of the clamp mechanism and a coupling system of the clamp mechanism with the motor mechanism, said system comprising a hollow shaft inside which the end of the shaft of the clamp mechanism can slide. The coupling system and the end of the shaft of the clamp mechanism are assembled together using a bayonet fixing in which the lugs belonging to said end are held, after rotation, by a stop arranged inside each hollow shaft.

Another aim of the present invention is to improve the instrument described in the paragraph above, in particular regarding the manner of realizing the bayonet fixing in order to facilitate coupling of the clamp mechanism with the motor mechanism.

To this end, according to the invention, the end of the shaft of the clamp mechanism comprises a cylindrical portion followed by a thinned down portion with a square section. A circular cut is formed in the thinned down portion, at the site of its connection with the cylindrical portion, this thinned down portion ending with the lugs of the bayonet fixing.

### BRIEF DESCRIPTION OF THE DRAWINGS

Other characteristics and advantages of the present invention will emerge from the description which follows, done in reference to the appended drawing in which:

FIG. 1 depicts a prior art embodiment;

FIG. 2 is a partial longitudinal cross-section of the instrument according to the invention in three characteristic positions shown in a, b and c;

FIGS. 3a and 3b illustrate the upstream end of the shaft of the clamp mechanism, seen from angles differing by 90°; and

FIG. 4 is a diametric cross-section along AA of the coupling system.

### MODE(S) FOR CARRYING OUT THE INVENTION

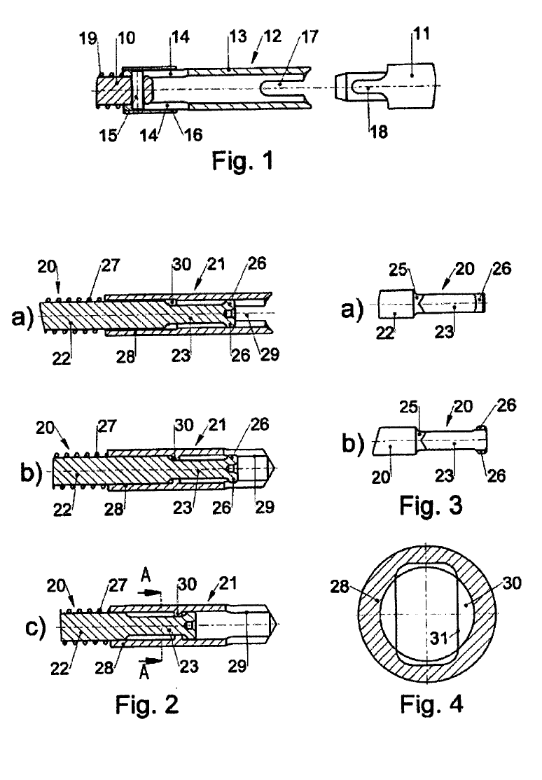

In FIG. 2, we have shown in 20 the upstream end of the shaft of the clamp mechanism and in 21 the system for coupling of the end 20 to the shaft of the motor mechanism (not illustrated but identical to that of FIG. 1). According to one main characteristic of the invention, the shaft of the clamp mechanism and the coupling system are assembled together using a bayonet fixing provided with lugs held by rotation.

As also shown in FIGS. 3a and 3b, the upstream end 20 of the shaft of the clamp mechanism comprises a cylindrical portion 22 followed by a thinned down portion with a square section 23. A circular cut 25 is formed in the thinned down portion 23, at the site of its connection with the cylindrical portion 22. Lastly, the thinned down portion 23 ends with two lugs 26, diametrically opposite, which are part of the bayonet fixing already mentioned.

One must also note the presence of a spring 27 arranged around the shaft portion 22 and having the same role as the spring 19 of FIG. 1.

We will now refer to FIG. 2 and also, more specifically, to FIG. 4, which show that the coupling system 21 comprises a hollow shaft 28 inside which the upstream end 20 of the shaft of the clamp mechanism is able to slide and the upstream end of which is provided with two diametrically opposite oblong axial notches 29 (only one of which appears in the drawing) having the same role as the notches 17 of FIG. 1.

The particularity of the hollow shaft 28 is to possess inside, substantially halfway between its ends, a wall 30 forming a stop and pierced with a rectangular window 31 formed and sized so as to allow only the two end lugs 26 of the shaft of the clamp mechanism to pass. The width of this window corresponds to the side of the thinned down portion 23. The wall 30 is shown from the downstream side in FIG. 4. One will note that the diameter of the thinned down portion 23 at the cut 25 corresponds to the width of the window 31, in order to allow its free rotation.

FIG. 2 shows, in a, b and c, the elements described above, respectively:
in a first extreme position, for which the upstream end 20 of the shaft of the clamp mechanism, after having gone through the window 31, is the most engaged in the hollow shaft 28;
in the same position, when the hollow shaft 28 has been turned by 90°; and
in a second extreme position, for which the upstream end 20 of the shaft of the clamp mechanism is the least engaged in the hollow shaft 28.

The connection of the end 20 of the shaft of the clamp mechanism and of the coupling system 21 is done as follows.

FIG. 2a

The end 20 of the shaft of the clamp mechanism is introduced into the hollow shaft 28, while orienting these two pieces by rotation such that the square portion 23 and the lugs 26 go through the window 31. The travel of the lugs is stopped when the cylindrical portion 22 abuts against the wall 30. The spring 27 is then compressed as much as possible. In this position, the circular cut 25 is located exactly in the window 31, which thus leaves it free to rotate.

FIG. 2b

The hollow shaft 28 is turned manually by 90°, since the cut 25 allows it.

FIG. 2c

All that remains, then, is to release the hollow shaft 28 which, under the return action exerted by the spring 27, will slide in the downstream direction on the square portion 23 until the lugs 26, now offset by 90°, no longer pass through the window 31 and abut on the wall 30. The junction is then realized.

The operations necessary for separation will follow an opposite path and therefore do not need to be described in detail.

It goes without saying that, in order to facilitate the 90° rotation for the operator, visual references may be placed on the clamp mechanism and the coupling system.

Thus is proposed a hand-held instrument in which the assembly of the clamp mechanism with the system allowing its coupling to the motor mechanism uses arrangements which are easy to realize, offers the operator great ease of use and guarantees holding capable of resisting a connection while the motor is still in rotation. Indeed, the cut 25 formed on the square portion of the shaft of the clamp mechanism is arranged sufficiently downstream so that, at the time of the connection of the motor mechanism to the coupling system, the hollow shaft 28 thereof is not pushed back to the point that its window 31 arrives at the cut.

1-3. (canceled)

4. A hand-held medical instrument designed to cause a removable tool to turn at high speed, comprising a clamp mechanism for the fixing of the tool, a motor mechanism to drive the clamp mechanism in rotation and a system for coupling the clamp mechanism with the motor mechanism, comprising a hollow shaft inside which the end of the shaft of the clamp mechanism can slide, said coupling system and the end of the shaft of the clamp mechanism being assembled together using a bayonet fixing in which lugs belonging to said end are held, after rotation, by a stop arranged inside said hollow shaft, wherein the end of the shaft of the clamp mechanism comprises a cylindrical portion followed by a thinned down portion with a square section, a circular cut being formed in said thinned down portion, at the site of its connection with said cylindrical portion, and wherein the thinned down portion ends with said lugs.

5. The instrument according to claim 4, wherein said hollow shaft has, inside, a wall forming said stop and pierced by a window formed and sized so as to allow said lugs to pass.

6. The instrument according to claim 5, wherein the diameter of said thinned down portion at said cut allows it to rotate freely inside said window.
